(19) United States
(12) Patent Application Publication
(10) Pub. No.: US 2008/0056142 A1
(43) Pub. Date: Mar. 6, 2008

(54) TEST METHOD FOR MESSAGE PATHS IN COMMUNICATIONS NETWORKS AND REDUNDANT NETWORK ARRANGEMENTS

(75) Inventors: Robert Arnold, Gelenau (DE); Thomas Hertlein, Munchen (DE); Jorg Kopp, Munchen (DE); Stefan Leitol, Munchen (DE); Rainer Schumacher, Munchen (DE); Robert Stemplinger, Munchen (DE)

Correspondence Address: BELL, BOYD, & LLOYD LLP, P.O. BOX 1135, CHICAGO, IL, 60690, US

(73) Assignee: Siemens Aktiengesellschaft, Munchen (DE)

(21) Appl. No.: 11/847,178

(22) Filed: Aug. 29, 2007

Related U.S. Application Data
(62) Division of application No. 10/648,832, filed on Aug. 27, 2003.
(60) Provisional application No. 60/406,309, filed on Aug. 28, 2002.
(60) Provisional application No. 60/429,313, filed on Nov. 27, 2002.

(30) Foreign Application Priority Data
Aug. 28, 2002 (EP) 02019298.5

(51) Int. Cl. G08C 15/00

(52) U.S. Cl. 370/248

(57) ABSTRACT

Disclosed are test methods for testing message paths in communication networks. Also disclosed are redundant network arrangements for rerouting information when faults are detected.

This application claims priority to European Application No. 02019298.5, filed Aug. 28, 2002, U.S. Provisional Application No. 60/406,309, filed Aug. 28, 2002, and U.S. Provisional Application No. 60/429,313, filed Nov. 27, 2002, the contents of which, are hereby incorporated by reference.

### FIELD OF THE INVENTION

Disclosed are Test methods for message paths in communication networks and network elements. Also disclosed are redundant network arrangements.

### BACKGROUND

Highly reliable communications systems often use redundant message paths to ensure that a fault affecting an individual message path does not lead to restrictions in communication. At the same time the redundancy of the message paths, i.e. for each message path there exists at least one alternate message path to which communication can be switched in the event of a fault, must be supported by the service platforms or hosts as well as by the communications system itself, i.e. by its elements, e.g. switches and routers, and its structure.

Moreover, for communications systems with real-time requirements, for example in the case of voice communication, very fast switchover times from a faulty message path to an alternate message path are also very important in order to limit to a minimum the negative effects on operation in the event of failure of a message path.

Faults to be taken into account include total failures and/or partial failures in individual elements of the communications system, e.g. service platform, switches, routers, and failures of the connections between the individual elements.

A communications system very often encountered in practice includes one or more hosts or service platforms that are connected to an IP network (IP=Internet Protocol) via a redundant local network LAN (LAN=Local Area Network) and two gateways.

The following means of checking message paths for freedom from faults are typically used:

IP Networks (Layer 3 Switching):

For the logical protocol level of the IP networks there exist standardized routing protocols such as e.g. Open Shortest Path First OSPF, Routing Information Protocol RIP, Border Gateway Protocol BGP, by means of which failures of a path can be detected and reported to other network elements in order to initiate a switchover to alternate routes. In this case the topology of the IP networks plays an insignificant role. The interruption of a message path which is connected directly to a network element is usually detected very quickly, e.g. inside 60 ms, and the switchover is typically completed after a few seconds, e.g. within 1.4 s.

The interruption of a message path which is not connected directly to the network element can only be communicated and detected by means of a routing protocol. In this case the switchover times are usually much greater and lie, for example, in the range of 30 s. to 250 s.

Local Area Networks LAN (Layer 2 Switching):

For the logical protocol level of the LANs there is no standardized procedure for detecting faulty message paths especially with redundant configurations with the structure referred to. In order to monitor host—LAN—gateway connections, the Spanning Tree Protocol SPT can be used, for example.

The SPT protocol is very slow-acting, however, i.e. a considerable period of time, for example about 30 s, is typically required in order to define a suitable alternate path. For this reason efforts are being made to introduce a faster form of SPT, called the Rapid Spanning Tree Protocol RSPT, which is described in IEEE Standard 802.1w. However, the monitoring times for RSPT are still in the range of several seconds (default value for bridge hello time=2 s).

For LANs with a ring topology, solutions are known, e.g. Ethernet Automatic Protection Switching EAPS or Resilient Packet Ring RPR, by means of which very short switchover times, e.g. less than 1 s, are to be achieved. However, all these methods use a LAN with ring topology, which is not the case in all application scenarios.

Considering the known methods for checking message paths described in the foregoing, the following problems result:
The known methods require special routing protocols which must be implemented in all network elements and/or are limited to specific network topologies.
If conventional test methods for message paths are used very frequently, for example by means of Internet Control Message Protocol ICMP PING or by means of RIP messages, the respective responder element which handles and responds to the test requirements is burdened with a considerable computing load.
The switchover times lie outside the tolerance range required for real-time communication.

### SUMMARY OF THE INVENTION

One embodiment of the present invention specifies a test method for message paths in communications networks as well as an improved network element, by means of which the disadvantages of the prior art are avoided.

One aspect of the present invention is a test method for message paths which can advantageously be used if two devices exchange messages of a first protocol layer, for example IP packets, via a communications network of a lower protocol layer, for example a LAN, the messages exchanged between the devices via the communications network being transmitted transparently, i.e. unmodified, through the communications network. According to the invention, a device initiating the test method sends test messages of the first protocol layer, e.g. special. IP packets, at short time intervals, the address of the first protocol layer, e.g. the IP address, of the initiating device being selected for such test messages both as the send address and as the receive address. It is also possible that the test method is executed by both devices, with the result that both (terminal) devices of a communications relationship know the status of the message paths.

A major advantage of the invention is that the test messages sent by the first to the second device are processed not by the switching processor of the second device, but already by the interface unit of the second device. In this way the test messages, which are sent frequently, for example every 100 ms, in order to detect faults on message paths as swiftly as possible, are prevented from generating processor load in the second device.

In a preferred embodiment, in which message paths of a LAN between a host and a gateway are tested, there is therefore an important advantage in the fact that the link test according to the invention does not lead to an overload situation at the gateway. In conventional implementations, PING or route-update messages and RIP messages are used at time intervals of 30 s to 300 s, as a result of which fast detection of faulty message paths, which is typically preferred for voice communication for example, is not possible. The use of the known ICMP PING or RIP messages would lead to overload if these messages were to be, sent at the high frequency mentioned, i.e. several times per second for each message path, when many hosts are connected.

By means of a timer it can advantageously be monitored whether the test messages were received correctly and within an expected time interval that is in line with the expected message transit time in the communications network via the message paths via which the test messages were sent. If test messages are not received or are received after the timer has elapsed, there is probably a fault on the corresponding message path. So that the loss of individual test messages does not lead to the false assumption that there is a general failure of the respective message path, the loss of multiple test messages can be used as a criterion for a fault on the message path.

The information concerning the faults on individual message paths can advantageously be used to select the optimal remaining message path in each case. Here, the optimal message path can be selected according to the chosen topology of the participating networks and taking into account factors such as costs associated with individual message paths and number of redundant interfaces or devices present.

The invention requires no modifications to be made to components of the communications network and can therefore be implemented easily and cheaply. Its realization is therefore simple and concerns only the device initiating the test.

Also provided according to the invention is a network element comprising means for executing this test method.

The present invention is also directed to a redundant network arrangement which advantageously allows for swift detection of faulty message paths and fast switchover to fault-free message paths.

The present invention is further directed to a redundant network arrangement which can be used with physically very remote network elements. At the same time the network arrangement incorporating long-distance or wide-area connections is intended to allow swift detection of faulty message paths and fast switchover to fault-free message paths.

According to the present invention, a network arrangement for a communications network N₁ which connects a first device Host and a second device G0, is provided,
including a first subnetwork N₀ and at least a second subnetwork N₁,
the first subnetwork (N₀) consisting of first switching elements S₀₀, S₀₁, S₀₂ and the second subnetwork N₁ consisting of second switching elements S₁₀, S₁₁, S₁₂, and
the first and the second subnetwork being set up independently of each other,
having at least one crosslink Q₁ between the subnetworks N₀, N₁, and
having at least a first link L₀₀ between the first subnetwork and a first interface IF0 of the first device Host and at least a second link L₁₀ between the second subnetwork and a second interface IF1 of the first device Host and having at least a third link L₀₃ between the first subnetwork and the second device G0,
links L₀₁, L₀₂ between the first switching elements S₀₀, S₀₁, S₀₂ and/or links L₁₁, L₁₂ between the second switching elements S₁₀, S₁₁, S₁₂ and/or the crosslink(s) Q₁ being implemented as wide area network connections WAN.

A major advantage of the invention is to be seen in the fact that when multiple devices Host are connected to the second device G0 by means of the network arrangement N according to the invention, each device Host has two redundant message paths to the second device G0 via two interfaces IF0, IF1. In this arrangement, one of the message paths runs via the crosslink Q₁ between the two redundant subnetworks, while the other runs within a subnetwork.

In a preferred embodiment, in which the message paths are formed by a network N between a host and a gateway G0, second gateway G1 can advantageously be used for reasons of reliability. This avoids the failure of the default gateway G0 leading to isolation of the entire network N.

In combination with the second gateway G1, multiple message paths advantageously result, said message paths enabling communication between hosts and at least one of the gateways G0, G1 even in the event of problems on individual message paths due to faulty connections or faulty switching elements.

A further advantage is that multiple hosts can communicate with one another by means of the crosslink(s) Q1 between the subnetworks N0 and N1 independently of the gateways, and furthermore can also do so when different interfaces of the hosts are active. For example, a first host with first active interface, connected to the first subnetwork N0, can exchange messages with a second host with second active interface, connected to the second subnetwork N1, via the crosslink(s). This would not be possible without the crosslink according to the invention.

Compared to the solutions in which only local area networks LAN are used in order to connect the first device Host and the further devices G0, G1, the use of wide area networks (WAN) according to one aspect of the invention allows much greater physical distances between the devices mentioned. This is of advantage, for example, when one of the redundant gateway devices G0, G1 is set up at a remote location, e.g. in order to reduce costs and to increase security and/or availability.

It is further of advantage that the network arrangement according to the invention considerably simplifies the administration of the overall network, since many hosts distributed over great areas can be reached from the centrally located gateway devices G0, G1 via only a single IP subnetwork. This minimizes the probability of an administration error and increases reliability.

In order to check the message paths, an advantageous test method for-message paths in communications networks can be used without modifications, since the long-distance (WAN) segments of the communications network forward the frames or packets of the networks N0, N1 or N01, N02, N11, N12 that are to be transported, transparently and so the end-to-end test of the paths between host and gateway(s) G0, G1 is not affected.

The invention is explained in greater detail below as an exemplary embodiment with reference to three figures.

### BRIEF DESCRIPTION OF THE DRAWINGS

The invention will be better understood by reference to the Detailed Description of the Invention when taken together with the attached drawings, wherein:

FIG. 1 shows a schematic representation of the connection of a host device to a gateway via a redundant network arrangement;

FIGS. 2A and 2B show a schematic representation of the execution sequence of a test between a host device and the gateway in a fault-free situation;

FIGS. 3-6 show a schematic representation of the execution sequence of a test in various fault situations;

FIG. 7 shows a schematic representation of the connection of multiple host devices to a gateway device via a redundant network;

FIG. 8A shows a schematic representation of the redundant connection of a host device to a local gateway device and to a remote gateway device by means of a wide area network;

FIG. 8B shows a schematic representation of the redundant connection of a host device to remote gateway devices by means of a wide area network;

FIG. 9A shows a schematic representation of the redundant connection of a host device to a local gateway device and to a remote gateway device by means of an Ethernet-over-SONET connection; and

FIG. 9B shows a schematic representation of the redundant connection of a host device to remote gateway devices by means of a resilient packet ring.

### DETAILED DESCRIPTION

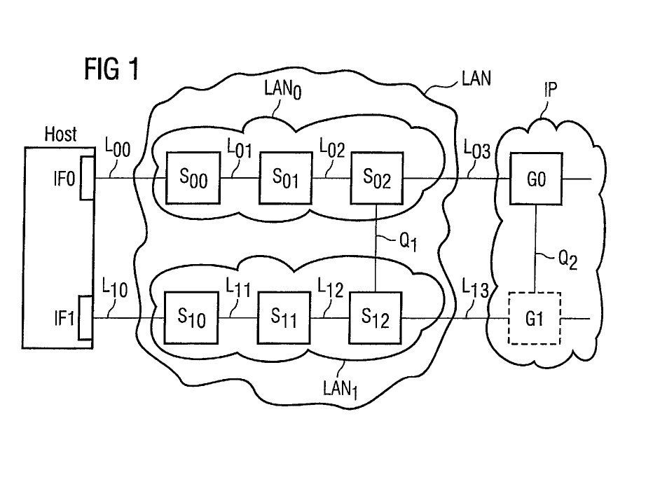

With reference to FIG. 1, the following paragraphs first describe an example of a redundant network topology for which the present invention can advantageously be used. Here, this topology serves to illustrate an exemplary embodiment of the invention, the invention being applicable to any topologies.

FIG. 1 shows a first device Host. This first device may, for example, be one of the hosts or service platforms referred to in the introductory remarks. However, the first device can be any communications device having L3 communications capabilities. For simplicity, the name Host will be used below to designate the first device.

The host is connected via a communications network N to a second device G0. This second device may, for example, be one of the gateways referred to in the introductory remarks. However, the second device can likewise be any communications device having L3 communications capabilities. For simplicity, the name Gateway will be used below to designate the second device.

In the preferred exemplary embodiment, the communications network N is a local area network LAN which operates e.g. according to the Ethernet standard. Other networks and/or protocols can be used for the transparent message transport between host and gateway.

Without special knowledge of the communications network N or its topology, the invention is already suitable for testing the message path or message paths via the communications network. However, the topology presented below is particularly suitable for use with the invention, particularly with regard to the possible alternate message paths in the event of a fault.

The communications network N is subdivided into two independent subnetworks N₀, N₁. In the simplest case this subdivision is implemented at logical level, but is also advantageously carried out physically in order to provide the greatest possible fault tolerance. In this scenario, N₀ includes a number of switching components or switches S₀₀, S₀₁, S₀₂. Three switching components are shown, although this number is purely exemplary and arbitrary from the point of view of this invention, in the same way as the structure of the subnetwork N₀ is arbitrary, being represented as linear only as an example.

The switches S₀₀, S₀₁ are connected by means of a link L₀₁, this link standing as representative of a logical, bidirectional connection between the switches; it can be formed physically, for example, by multiple links. In the same way the switches S₀₁, S₀₂ are connected by means of a link L₀₂.

Subnetwork N₁ includes a number of switching components or switches S₁₀, S₁₁, S₁₂. Three switching components are shown, although this number is simply an example and arbitrary from the viewpoint of this invention, in the same way as the structure of the subnetwork N₀ is arbitrary, being represented as linear only by way of example. The switches S₁₀, S₁₁ are connected by means of a link L₁₁, this link standing as representative of a logical, bidirectional connection between the switches and can be formed physically, for example, by multiple links. In the same way the switches S₁₁, S₁₂ are connected by means of a link L₁₂.

N₀ is connected to the host via a link L₀₀. N₁ is connected to the host via a link L₁₀. Here, the host has two separate interfaces IF0, IF1, a first interface IF0 serving the connection to subnetwork N₀ and a second interface IF1 serving the connection to N₁.

A link L₀₃ serves to connect subnetwork N₀ to the gateway G0. Depending on the type of redundancy topology, subnetwork N₁ likewise possesses a connection to gateway G0—not shown—and/or, via at least one crosslink Q₁, to subnetwork N₀. Advantageously, this crosslink is implemented as closely as possible to the transition point from N₀ to the gateway G0, i.e. for example between S₀₂ and S₁₂ as shown in FIG. 1. If the crosslink Q₁ is not disposed directly at the transition from N₀ to the gateway G0, suitable protocols can be used to avoid L2 loops in connection with the present invention. It is understood that the crosslink Q₁ may physically include multiple links.

In an alternative embodiment, a standby gateway G1—represented by dashes—is provided in addition to the gateway G0, for example in case of the failure of the gateway G0. Here, the gateways G0, G1 can likewise be connected by means of a crosslink Q₂. A link L₁₃ connects N₁ and gateway G1. Depending on the type of redundancy topology, N₀ likewise possesses a connection to gateway G1—not shown.

The gateways G0, G1 can be prioritized by suitable administration of the routing tables. For example, the connection of gateway G0 into the further IP network IP can be set up as a lower-cost route, and the connection of gateway G1 into the further IP network IP can be set up as a higher-cost route. Prioritization is a means of ensuring, in the event of a fault on the crosslink Q₁, that the host always uses the network (in this case: N₀) connected to the default gateway G0 for communication.

However, such a prioritization is not required in all cases, for example if the crosslink Q₁ physically includes multiple links—not shown. In this case the prioritization is not necessary, since at least one further link is available in the event of the failure of one of these links.

Based on the network topology presented, the following message paths, for example, result; only network-internal paths are considered here:
Path1: Host<->IF0<->N₀<->G0<->IP
Path2: Host<->IF1<->N₁<->Q₁<->S₀₂<->G0<->IP
Path3: Host<->IF0<->N₀<->Q₁<->S₁₂<->G1<->IP
Path4: Host<->IF1<->N₁<->G1<->IP

If the mentioned prioritization is provided for the gateways G0, G1, and if the interfaces IF0, IF1 are also prioritized in addition, IF0, for example, having the higher priority, the following prioritization of the paths mentioned results, provided the gateway prioritization is to take precedence over the interface prioritization:
Path1>Path2>Path3>Path4

Further message paths are produced in similar fashion if the cited crossover connections from N₀ to G1 and N₁ to G0 are present and/or if further crosslinks or also crossover connections exist inside the communications network N between subnetworks N₀ and N₁.

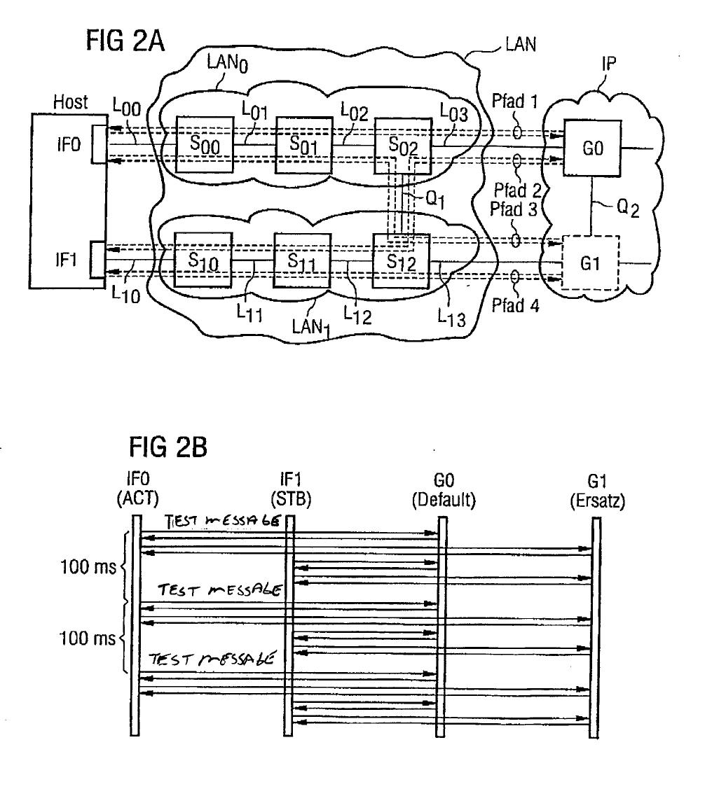

FIG. 2 shows the communications network N from FIG. 1 in a schematic view with the test messages transported through the communications network in the fault-free case. Here, FIG. 2A shows the path taken by the test messages through the communications network N. FIG. 2B shows a diagram with time sequences, this diagram being greatly idealized in the sense that the transit times of the test messages are not considered separately. Moreover, only test messages are considered in diagram 2B, but not user data.

The message paths are now tested, in that the host sends special test IP datagrams via each interface IF0, IF1 to each gateway G0, G1 at very short time intervals, e.g. every 100 ms. The IP address of the respective dedicated interface IF0 or IF1 is entered as both source IP address and as destination IP address. Thus, the test packet is mirrored back to the sending interface IF0, IF1 of the host by the gateway.

The following table shows the IP and MAC addresses to be chosen for testing the message paths Path1 . . . Path4:

| | Path1 | Path2 | Path3 | Path4 |
|---|---|---|---|---|
| Destination MAC | G0 | G0 | G1 | G1 |
| Source MAC | IF0 | IF1 | IF0 | IF1 |
| Destination IP | IF0 | IF1 | IF0 | IF1 |
| Source IP | IF0 | IF1 | IF0 | IF1 |

Basically, therefore, the layer 2 messages are addressed correctly using the respective MAC (MAC=Media Access Control) addresses, whereas the addressing of the higher layer 3 messages is modified such that the layer 3 messages are routed back to the sending entity. This principle is based on the fact that as a rule layer n messages are not modified during transport through a layer n-1 network and that layer n address information is not interpreted by the layer n-1 network.

For IP test messages, an important advantage is that only the “IP forwarding” function, which is implemented on the very powerful interface cards of the gateways, is required for mirroring or sending back the test messages to the sending entity. Thus, an overload situation in the gateway due to the method according to the invention cannot occur, since the switching processor of the gateways is not involved in any way in the processing of the test messages.

If the test message mirrored at the respective destination is not received again by the host within a specific period of time, e.g. 100 ms, there is probably a fault on the corresponding message path. This is recorded in a storage buffer for example. In a development of the invention, the fault on the message path is only recorded as a permanent fault if the following test message associated with this message path is also not received again at the host. In a further development, the number of consecutive messages that may be lost per message path before this is interpreted as a fault can be adapted to the particular requirements.

Alternatively, it is also possible to identify the transmitted test messages by means of consecutive numbers or sequence numbers. These are entered in the payload of the test messages. The loss of a configurable number of not necessarily sequential test messages can also be used as a criterion for failure detection, i.e. the message paths are monitored by numbering of the test messages. In this case the counter for lost test messages can be designed such that a lost test message increments the counter by 1 and a configurable number of test messages received without loss, e.g. 1000, decrements the counter by 1. Alternatively, the counter can be decremented upon expiration of a time interval during which no test message loss has occurred. If the counter reaches a limit value, the message path is deemed faulty.

If the message paths are checked at sufficiently short time intervals with the aid of the method according to the invention, every 100 ms in the exemplary embodiment described, and if a failed test is repeated precisely once before the corresponding path is deemed faulty, the message path will be recognized as faulty after a very short delay, in this case 200 ms, if the repeated test fails.

With reference to the actual application scenario, it is a straightforward matter for the person skilled in the art to adapt the described parameters of the test method according to the invention to the particular application.

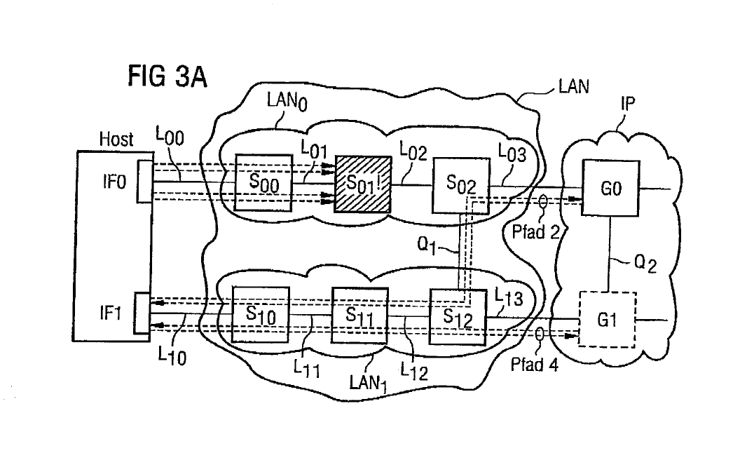

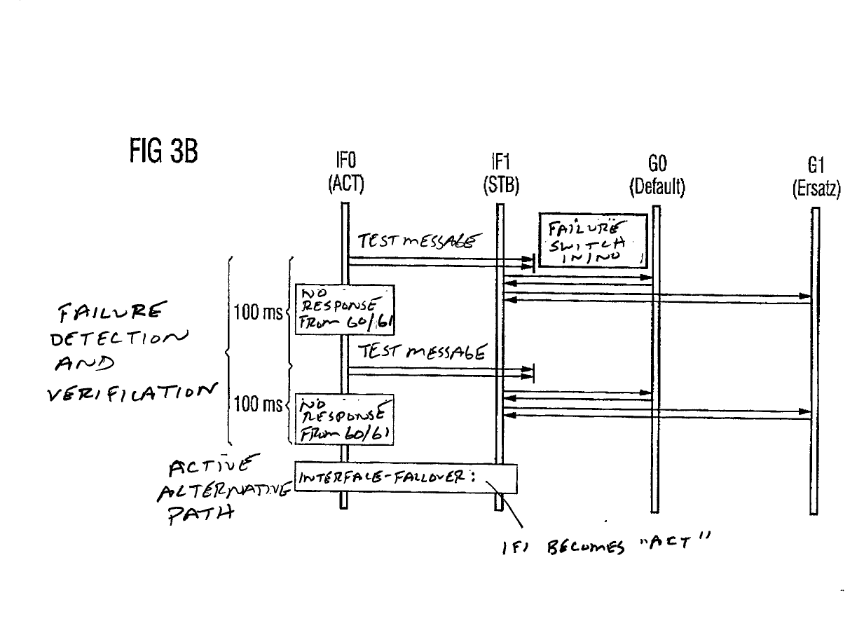

After a fault has been detected and recorded, the user data traffic of the faulty message path is redirect to a fault-free message path. The methods for doing this are well-known. However, advantageous strategies for selecting the alternate message path are presented below with reference to FIGS. 3 to 6, where FIGS. 3 to 6 contain examples of faults on message paths.

FIG. 3A shows the failure of a switch in subnetwork N₀ that is not connected to the crosslink Q₁, in this case switch S₀₁ for example. As a result, paths 1 and 3 become faulty. Paths 2 and 4 are fault-free. The corresponding signal flow is shown in FIG. 3B. Test messages are sent to both gateways G0 and G1 by interface IF0, which is shown as the active (ACT) interface up to that point. The test messages are lost on account of the failure, however. After the test fails twice in succession, the fault on Path1 and Path3 is recognized. Test messages are sent to both gateways G0 and G1 from interface IF1, which is shown as a standby (STB) interface. These test messages are received again accordingly. Path2 and Path4 are recognized as fault-free. According to the prioritization of the message paths, Path2 is activated as an alternate path by switching interface IF1 from STB to ACT. The status “faulty”, for example, is recorded for interface IF0 and, if necessary, an alarm is triggered to alert operating personnel.

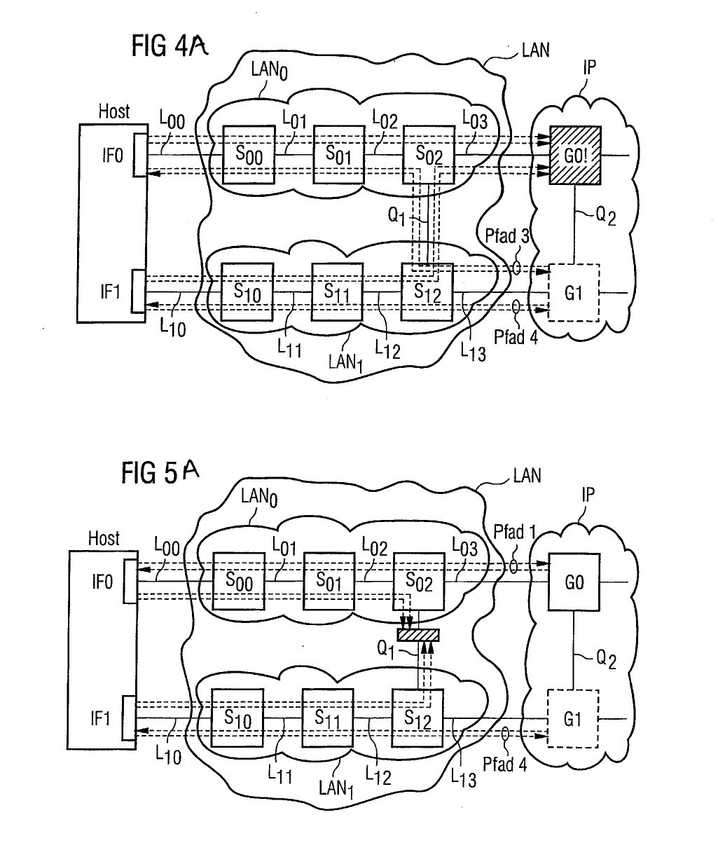

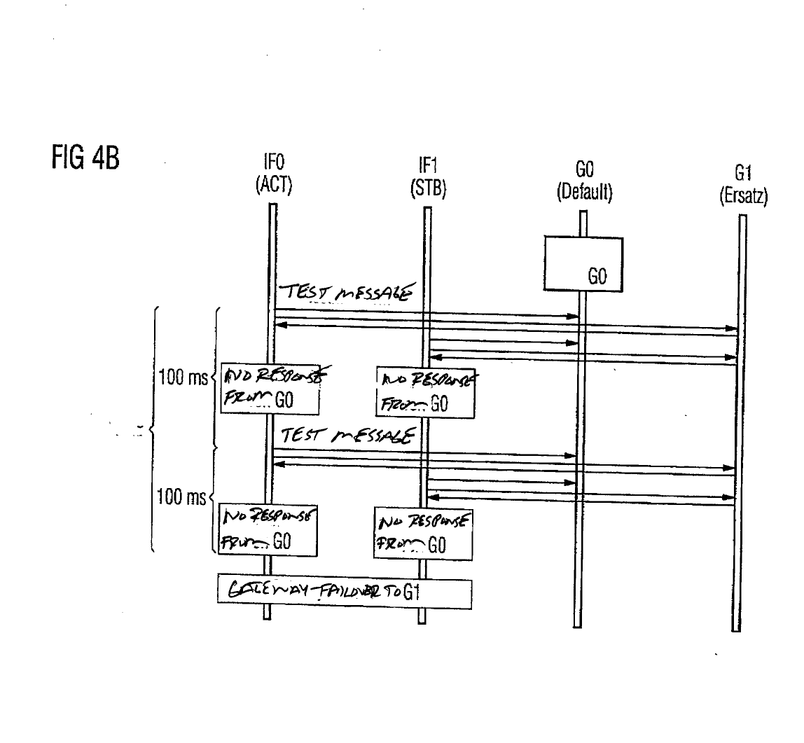

FIG. 4A shows the failure of gateway G0. As a result, paths 1 and 2 become faulty. Paths 3 and 4 are fault-free. The corresponding signal flow is shown in FIG. 4B. Test messages are sent to the default gateway G0 by both interfaces IF0, IF1. The test messages are lost on account of the failure, however. After the test fails twice in succession, the fault on Path1 and Path2 is recognized. Test messages are sent to the standby gateway G1 by both interfaces IF0, IF1. These test messages are received again accordingly. As a result, Path3 and Path4 are recognized as fault-free. According to the prioritization of the message paths, Path3 is activated as an alternate path by executing a so-called gateway failover (switchover to the standby gateway). The status “faulty”, for example, is recorded for gateway G0 and, if necessary, an alarm is triggered to alert operating personnel.

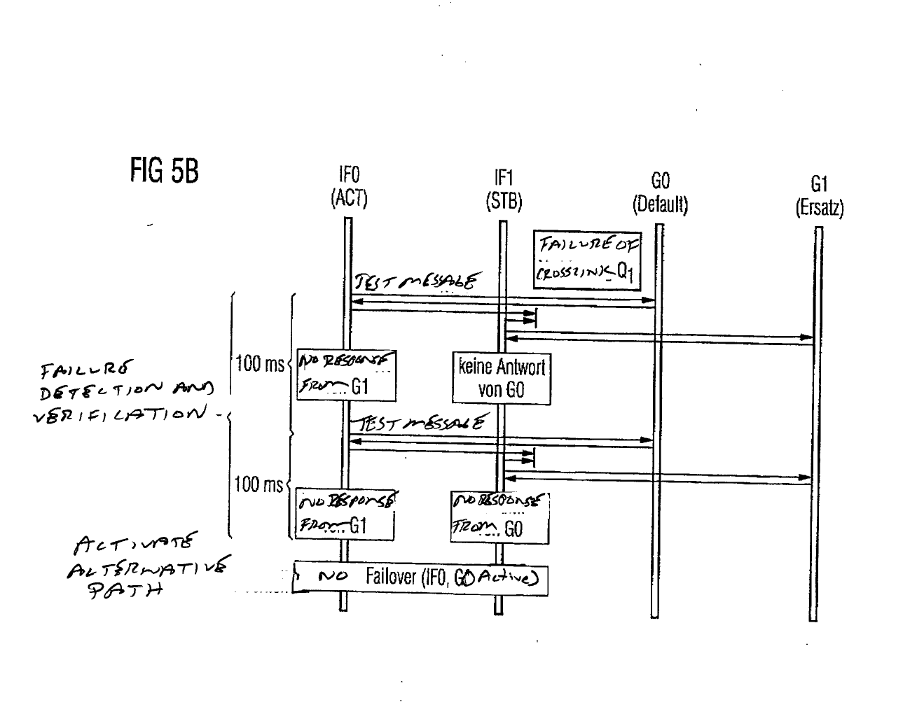

FIG. 5A shows the failure of a crosslink Q₁ between subnetworks N₀ and N₁. As a result, paths 2 and 3 become faulty. Paths 1 and 4 are fault-free. The corresponding signal flow is shown in FIG. 5B. Test messages are sent to gateway G1 by interface IF0, which is shown as the active (ACT) interface up to that point. The test messages are lost on account of the failure, however. After the test fails twice in succession, the fault on Path3 is recognized. Test messages are sent to gateway G0 by interface IF1, which is shown as a standby (STB) interface. The test messages are lost on account of the failure, however. After the test fails twice in succession, the fault on Path2 is recognized. Test messages are sent to gateway G0 by interface IF0. These test messages are received again accordingly. Path1 is regarded as fault-free. Test messages are sent to gateway G1 by interface IF1. These test messages are received again accordingly. Path4 is regarded as fault-free. According to the prioritization of the message paths, Path1 remains active, although a message can be sent to notify operating personnel that a fault is present.

If Path1 also becomes faulty as a result of a further failure without the fault on paths 2 and 3 being rectified, a failover is then made directly to the lowest prioritized path 4. As the fault information is always current because of the tests continuing to be run every 100 ms even for faulty paths, this failover can be effected without delay, without a failover to paths 2 or 3 being attempted first.

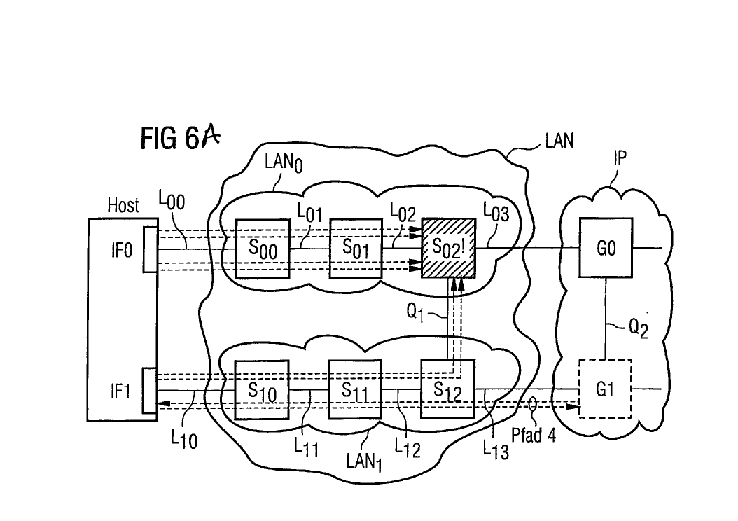

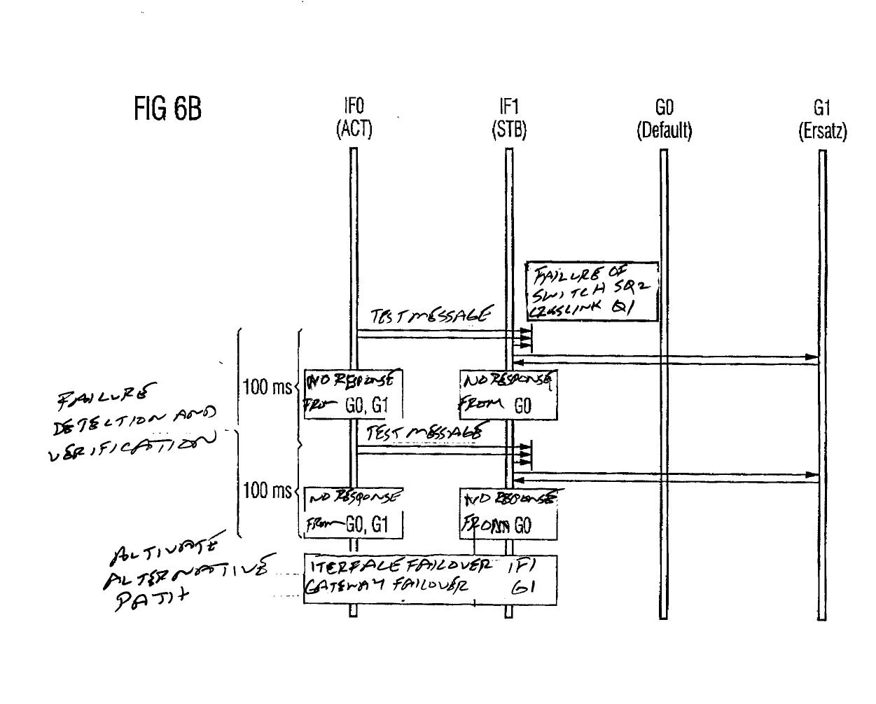

FIG. 6A shows the failure of a switch in subnetwork N₀ that is connected to the crosslink Q₁, in this case switch S₀₂ for example. As a result, paths 1, 2 and 3 become faulty. Path 4 is fault-free. The corresponding signal flow is shown in FIG. 6B. Test messages are sent to both gateways G0 and G1 by interface IF0, which is shown as the active (ACT) interface up to that point. The test messages are lost on account of the failure, however. After the test fails twice in succession, the fault on Path1 and Path3 is recognized. Test messages are sent to gateway G0 by interface IF1, which is shown as a standby (STB) interface. The test messages are lost on account of the failure, however. After the test fails twice in succession, the fault on Path2 is recognized. Test messages are sent to gateway G1 by interface IF1. These test messages are received again accordingly. As a result, Path4 is recognized as fault-free. Since Path4 is the only remaining path, it is activated as an alternate path by switching interface IF1 from STB to ACT. The status “faulty”, for example, is recorded for interface IF0 and, if necessary, an alarm is triggered to alert operating personnel. A separate alarm that indicates that no further alternate message path is present, and that therefore any further failure will lead to total failure, can also be triggered.

The failover strategy described with reference to FIGS. 3 to 6 is illustrated in the following table. The meaning of the various symbols is as follows:

| | |
|---|---|
| “x” | Path fault-free |
| “o” | Status of the path is irrelevant |
| “—” | Path faulty |
| “P1 . . . P4” | Path1 . . . Path4 |
| IF-FO | Interface failover |
| G-FO | Gateway failover |

| P1 | P2 | P3 | P4 | Response | Possible cause |
|---|---|---|---|---|---|
| x | o | o | o | No FO (IF0/G0 | N₀ and G0 fault-free |
| | | | | active) | (N₁, Q₁, G1 may be faulty) |
| — | x | o | o | IF-FO to IF1 | Failure of switch or link |
| | | | | | in N₀ |
| — | — | x | o | G-FO to G1 | G0 failure |
| — | — | — | x | IF-FO to IF1 and G- | Failure of switch with |
| | | | | FO to G1 | crosslink Q₁ in N₀ |
| — | — | — | — | No FO (IF0 active) | G0 and G1 failure |

Here, a gateway failover means that the host uses a different gateway for sending IP packets in the direction of the IP network, whereas interface failover means that the host uses a different interface for sending and receiving messages. For “internal” communication, i.e. communication between multiple hosts connected to the communications network N—not shown, it is preferred that all hosts always have a connection to the same default gateway G0 or G1. In this way, host-to-host communication is ensured even in the event of partial failures, for example failures of the crosslink path Q1. A failover to the standby gateway G1 is effected only if the default gateway G0 cannot be reached either via IF0 or via IF1, which is also reflected in the prioritization of the paths.

Although the exemplary embodiment of the invention is described with reference to an IP/LAN environment, the invention is not limited to this protocol environment. Connection-oriented protocols can, for example, be used for monitoring the host-gateway connection if these support a connection setup “to itself”, i.e. source address=destination address. If an interruption to the connection is detected by the protocol, a failover to a redundant transmission path can be initiated. Examples of such protocols are the Real Time Protocol RTP or Stream Control Transmission Protocol SCTP.

In certain networks it may be necessary for both the first device Host and also the second and third devices G0, G1 to know the status of all message paths. In order to achieve this, the method according to the invention can be implemented for all devices that need to know the status of the message paths. Alternatively, the status can be transmitted by means of status messages from one device executing the test method to all other devices. The advantage of the present invention is that the test messages initiated by different devices, e.g. multiple hosts, do not mutually influence one another.

An exemplary network element Host, for which the method described in the foregoing is implemented, comprises, in addition to send-receive devices or interfaces IF0, IF1 to the communications network N, for example control logic which converts the described method. Control logic of this type also has a device for providing test messages having destination addresses and source addresses, e.g. source IP address and destination IP address, which correspond to the address of the network element and/or its interfaces.

The control logic further comprises devices for monitoring the individual message paths. In this case the message paths can be predetermined by operator intervention or determined automatically by suitable processes.

The control logic establishes on the basis of the criteria already explained in detail whether a message path is faulty and initiates the selection and failover to an alternative message path according to the failover strategy. For this purpose, the control logic has suitable switchover elements, as well as storage elements in which the prioritization of individual message paths is stored.

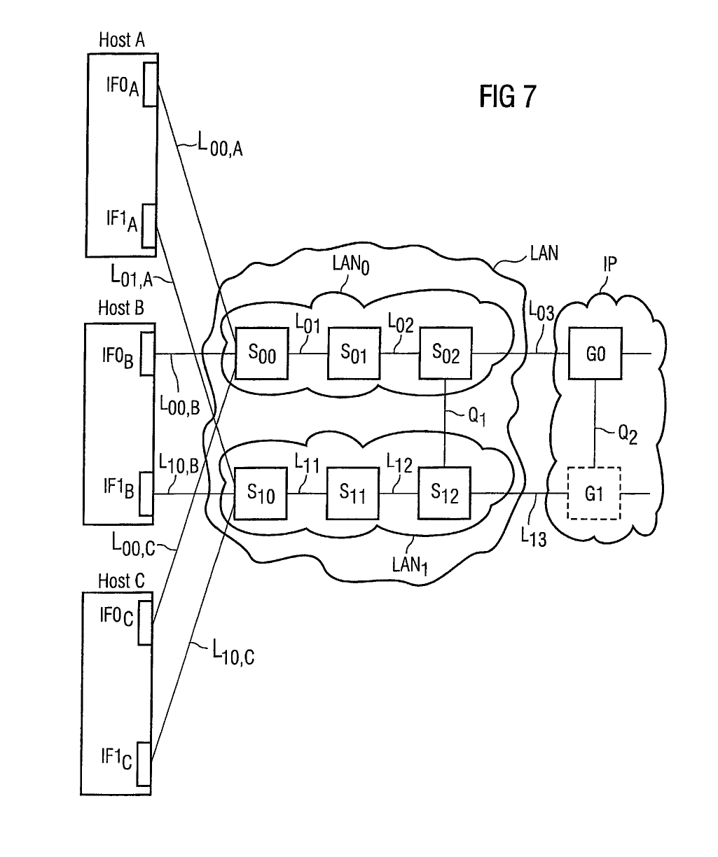

FIG. 7 shows an embodiment of the invention comprising three host components designated Host A, Host B and Host C connected to gateway G0 via the communications network N. By prioritizing the interfaces IF0, IF1 of all hosts it is achieved that all hosts always communicate via the same interface, e.g. IF0, such that a local host-to-host communication is possible even in the event that the communication with gateways G0 an G1 is interrupted.

Although multiple crosslinks can be provided between the subnetworks N₀, N₁, it is advantageous to provide only one crosslink Q₁ at the switches located nearest to the gateways G0, G1. In this way Layer 2 loops and hence the use of a Spanning Tree Protocol SPT can be avoided.

However, prioritization is not necessary in all cases, for example if the crosslink Q₁ physically includes multiple links—not shown. In this case the prioritization is not required, since at least one further connection is available if one of these connections fails.

The links L₀₁, L₀₂ and L₁₁, L₁₂ between the switching elements S₀₀, S₀₁, S₀₂ and S₁₀, S₁₁, S₁₂ shown in FIGS. 1 through 7 and also the crosslink Q₁ are conventionally implemented as local connections, as a result of which the networks N₀ and N₁ are pure local area networks LANs in one embodiment. On the other hand, physically remote arrangements between host device and gateway device(s) can be implemented by configuring all or a selection of the mentioned links, e.g. with regard to Layer 1, as long-distance (WAN) connections.

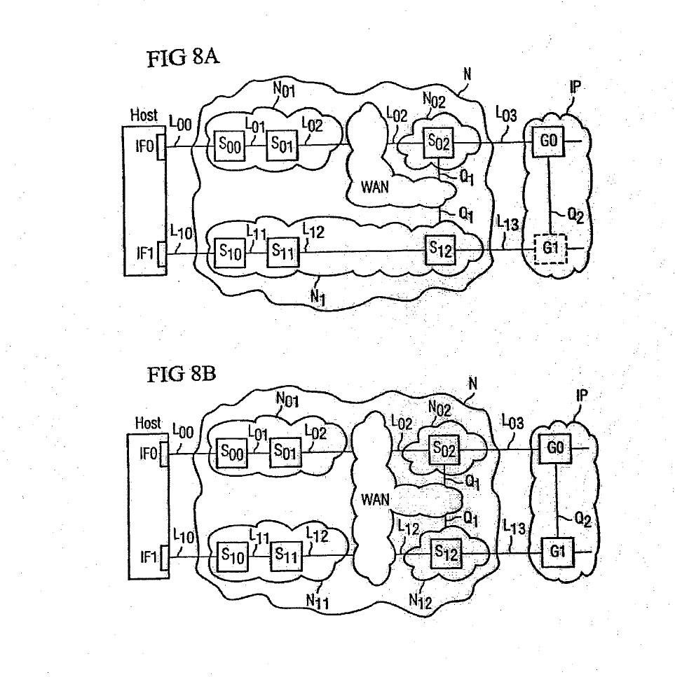

This is shown schematically in FIGS. 8A and 8B. FIG. 8A provides a remote gateway device G0, which is connected to a host component by means of a local area network N₀, including the switches S₀₀ and S₀₁ as well as the link L₀₁, a schematically represented wide area network WAN and a second local area network N₀₂ including the switch S₀₂. Furthermore, the crosslink between the subnetworks N₀₂ and N₁ is likewise routed through the wide area network WAN. With reference to the schematic representation from FIG. 7, the links L₀₂ and Q₁ are implemented in FIG. 8A as long-distance (WAN) connections; the connection of the optional second, local, gateway G1 is implemented by means of the local area network N₁.

In FIG. 8B, the host device is connected to two remote gateway devices G0, G1. The redundant connection is achieved on the one hand by means of a local area network N₀₁ including the switches S₀₀ and S₀₁ and also the link L₀₁ and a local area network N₀₂ including switch S₀₂, the local area networks N₀₁ and N₀₂ being connected by means, of a wide area network WAN, as well as on the other hand by means of a local area network N₁₁ including the switches S₁₀ and S₁₁ as well as the link L₁₁ and a local area network N₁₂ including switch S₁₂, the local area networks N₁₁ and N₁₂ being connected by means of the wide area network WAN. With reference to the schematic representation from FIG. 7, the links L₀₂, L₁₂ and Q₁ are implemented in FIG. 8A as long-distance (WAN) connections.

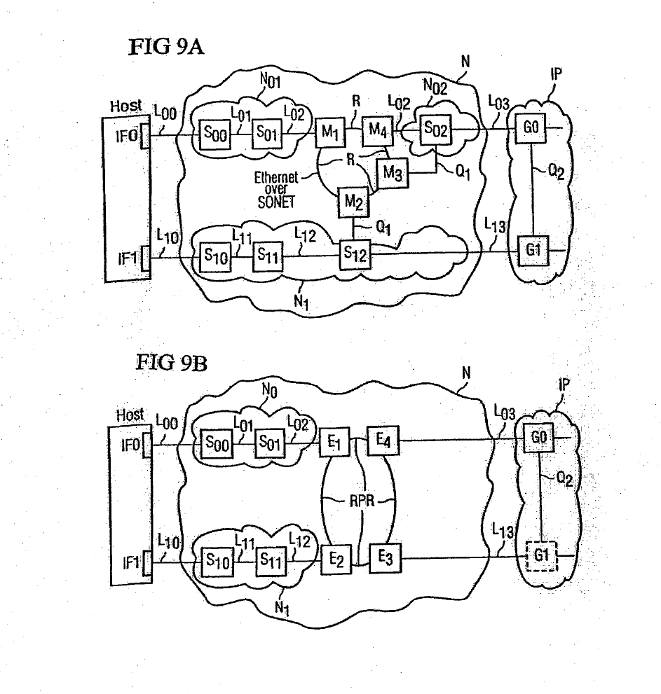

The exemplary embodiments of the connection of a host device to gateway device(s) represented schematically in FIG. 8 will now be explained in more detail with reference to FIGS. 9A and 9B.

Taking the schematic view from FIG. 8A as a basis, FIG. 9A shows the case of a host device connected to a local gateway G1 and a remote gateway G0. Here, the host device is connected to the local gateway G1 by means of a local area network (e.g. LAN) N1. As described in connection with FIG. 8A, in FIG. 9A the link L02 and the crosslink Q1 are formed by means of a long-distance (WAN) connection (WAN=Wide Area Network). In the example shown in FIG. 9A, the WAN is configured as an Ethernet-over-SONET ring. In this case four elements, preferably four ADD/DROP multiplexers M1, M2, M3, M4, are disposed in a ring structure, i.e. ring R connects M1 to M2, M2 to M3, M3 to M4 and M4 to M1, in each case bidirectionally. As a special case, the SONET ring is preferably configured such that point-to-point connections are implemented.

The message paths represented schematically in FIG. 2A can be implemented in the exemplary embodiment in FIG. 9A, for example as follows:
Path1: Host<->IF0<->N₀₁<->M₁<->M₄<->N₀₂<->IP
Path2: Host<->IF1<->N₁<->M₂<->M₃<->N₀₂<->IP
Path3: Host<->IF0<->N₀₁<->M₁<->M₂<->N₁<->IP
Path4: Host<->IF1<->N₁<->IP

Here, the redundant ring structure permits the configuration of alternate paths. For example, if the ring segment between M₁ and M₄ fails, this section of Path1 can be alternately switched as follows:
M₁<->M₂<->M₃<->M₄ or
M₁<->M₂<->M₃<->N₀₂

In similar fashion, internal alternate paths with regard to the WAN can be specified for other failures; methods in this respect are sufficiently known.

Taking the schematic view from FIG. 8B as a basis, FIG. 9B shows the case of a host device connected to two remote gateways G0, G1, gateway G1 being optional. Here, the host device is connected to gateway G0 by means of a local area network (e.g. LAN) N₀ as well as a resilient packet ring RPR conforming to IEEE 802.17 or a comparable WAN ring (e.g. Extreme Networks Ethernet Automatic Protection Switching EAPS or Cisco Resilient Packet Ring Technology). Link L₀₂ connects the subnetwork N₀ to the RPR, the latter being represented by way of example as including four Ethernet switches (preferably Gigabit Ethernet) E₁, E₂, E₃, E₄ and a ring connection RPR. The ring RPR connects E₁ to E₂, E₂ to E₃, E₃ to E₄ and E₄ to E₁, in each case bidirectionally.

In contrast to the arrangement represented in FIG. 8B, in FIG. 9B the connection between the WAN and the gateways is implemented directly by means of the links L₀₃ and L₁₃, but can also include further elements, as shown in FIG. 8B. The crosslink Q₁ is formed by the RPR. Viewed schematically, the RPR in FIG. 9B replaces the switches S₀₂ and S₁₂ and also the crosslink Q₁ from FIG. 1.

The connection of the host device to the (optional) gateway G1 is implemented by means of a local area network (e.g. LAN) N₁ and the RPR. Link L₁₂ connects the subnetwork N₁ to the RPR.

The message paths represented schematically in FIG. 2A can be implemented in the exemplary embodiment in FIG. 9B, for example as follows:
Path1: Host<->IF0<->N₀<->E₁<->RPR<->E₄<->IP
Path2: Host<->IF1<->N₁<->E₂<->RPR<->E₄<->IP
Path3: Host<->IF1<->N₀<->E₁<->RPR<->E₃<->IP
Path4: Host<->IF0<->N₁<->E₂<->RPR<->E₃<->IP

How the communications paths run in the RPR in this case depends on the current state of the ring itself and is not important for the method described here, since the redundant ring structure and the ring protocol ensure the automatic configuration of alternate paths. For example, if the ring segment between E₁ and E₄ fails, this section is alternately switched by the ring protocol as follows: E₁<->E₂<->E₃<->E₄.

In similar fashion, internal alternate paths with regard to the WAN can be specified for other failures; methods in this respect are sufficiently known.

The network arrangement according to the invention can advantageously be combined with the method for testing the message paths described above.

After a fault has been detected and recorded, the user data traffic of the faulty message path is redirected to another, fault-free, message path. The methods for doing this are well-known. For example, the host sends a “gratuitous ARP”, i.e. an ARP request in respect of its own IP address. The host uses the interface from which the request originates as the source MAC address, and its own IP address as the sought IP address. As a result of the ARP broadcast, the ARP caches of all connected hosts and gateways are updated with the MAC/IP address relation. The switchover is effected, for example, to the mentioned alternate message paths, which are selected according to their prioritization.

With SONET and Resilient Packet Ring, the present invention has been described for two typical redundant WAN methods. Other WAN methods can, of course, also be applied to the present invention, particularly in connection with the theory outlined in FIGS. 1, 2A, 8A and 8B.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

Other embodiments and uses of the invention will be apparent to those skilled in the art from consideration of the specification and practice of the invention disclosed herein. All references cited herein, including all written publications, all U.S. and foreign patents and patent applications, and all published statutes and standards, are specifically and entirely incorporated by reference. It is intended that the specification and examples be considered exemplary only with the true scope and spirit of the invention indicated by the following claims.

1-15. (canceled)

16. A network arrangement for a communications network which connects a first device and a second device, comprising a first subnetwork and at least a second subnetwork, wherein the first subnetwork comprises first switching elements and the second subnetwork comprises second switching elements, and wherein the first and the second subnetwork are set up independently of each other, having at least one crosslink between the subnetworks and having at least a first link between the first subnetwork and a first interface of the first device and at least a second link between the second subnetwork and a second interface of the first device and having at least a third link between the first subnetwork and the second device, wherein links between the first switching elements and/or links between the second switching elements and/or the crosslink(s) are configured as long-distance connections.

17. The network arrangement of claim 16, wherein at least one of the crosslinks is disposed directly at the transition of the communications network to the second device.

18. The network arrangement of claim 16, wherein at least one of the crosslinks is disposed directly at the transition of the communications network to the second device.

19. The network arrangement of claims 18, wherein the communication between the first and the second and/or third device is effected by means of messages of a first protocol layer, which are transmitted in the communications network by means of a second protocol layer that is subordinate to the first protocol layer.

20. The network arrangement of claim 18, wherein the first protocol layer is formed by the Internet Protocol IP and the second protocol layer is formed by a protocol of a local area network LAN.

21. The network arrangement of claim 20, wherein the long-distance connections are implemented as Ethernet-over-SONET connections.

22. The network arrangement of claim 20, wherein the long-distance connection(s) are implemented as a resilient packet ring RPR.

23. A network arrangement for a communication network which connects a first device and a second device comprising:
a first subnetwork and a second subnetwork, the first subnetwork comprising first switching elements and the second subnetwork comprising second switching elements, and
wherein the first and the second subnetwork are set up independently of each other,
having at least one crosslink between the subnetworks and
having at least a first link between the first subnetwork and a first interface of the first device and at least on second link between the second subnetwork and a second interface of the first device and
having at least a third link between the first subnetwork and the second device.

24. The network arrangement of claim 23, wherein the crosslink(s) are disposed directly at the transition of the communications network to the second device.

25. The network arrangement of claim 23, further comprising a fourth link between the first subnetwork and a third device of the same type as the second device.

26. The network arrangement of claim 23, wherein the communication between the first and the second and/or third device is effective by means of messages of a first protocol layer, which are transmitted in the communications network by means of a second protocol layer that is subordinate to the first protocol layer.

27. The network arrangement of claim 23, wherein that the first protocol layer is formed by the Internet Protocol IP and the second protocol layer is formed by a protocol of a local area network LAN.
